(19) United States
(12) Patent Application Publication
(10) Pub. No.: US 2024/0256917 A1
(43) Pub. Date: Aug. 1, 2024

(54) ONTOLOGY-DRIVEN PARAMETER EFFICIENT REPRESENTATIONS FOR KNOWLEDGE GRAPHS

(71) Applicant: Accenture Global Solutions Limited, Dublin (IE)

(72) Inventors: Eda Bayram, Dublin (IE); Luca Costabello, Newbridge (IE)

(21) Appl. No.: 18/161,260

(22) Filed: Jan. 30, 2023

(51) Int. Cl. G06N 5/022; G06N 3/042

(52) U.S. Cl. CPC G06N 5/022; G06N 3/042

(57) ABSTRACT

Methods, systems and apparatus, including computer programs encoded on computer storage medium, for training a neural link predictor. In one aspect a method includes obtaining triples that represent a knowledge graph, where each triple comprises specifies a subject and object node in the knowledge graph and a relation type between the subject node and object node; obtaining data that specifies entity types of nodes in the knowledge graph; and for each triple: retrieving, from an ontology lookup table, ontology embeddings for the knowledge graph, the ontology embeddings comprising embeddings for each entity type in the set of entity types, generating, using the retrieved ontology embeddings for the knowledge graph, node embeddings for the subject node and the object node included in the triple, scoring the triple using the generated node embeddings, and updating, using a loss of the scored triple, the ontology embeddings stored in the ontology lookup table.

### TECHNICAL FIELD

This specification generally relates to methods, systems, and devices for machine learning.

### BACKGROUND

Knowledge graphs are graph datasets that represent networks of real-world entities and characterizes the relationships between them. Example entities include objects, events, situations, or concepts. Knowledge graphs include a set of nodes and a set of edges, where the nodes represent respective entities and edges between nodes define relationships between the nodes.

Graph machine learning is a family of machine learning methods designed to learn from graph datasets with the goal of inferring missing information, e.g., predicting missing edges between nodes of a graph. Graph machine learning includes node representation learning models based on graph features, graph neural networks, and neural link predictors. A neural link predictor (also referred to as Knowledge Graph Embedding model) is an artificial neural network architecture that learns vector representations (referred to as “embeddings”) of concepts by a training a knowledge graph to predict missing, unseen links between nodes.

### SUMMARY

This specification describes systems and methods for predicting missing links in knowledge graphs using memory-efficient embeddings learned by ontology-driven encodings.

In general, one innovative aspect of the subject matter described in this specification may be embodied in methods for training a neural link predictor, the method including obtaining a plurality of triples that represent a knowledge graph, wherein each triple in the plurality of triples comprises data that specifies a subject node in the knowledge graph, an object node in the knowledge graph, and a relation type between the subject node and object node; obtaining data that specifies a set of entity types of nodes in the knowledge graph; and for each triple: retrieving, from an ontology lookup table, ontology embeddings for the knowledge graph, the ontology embeddings comprising embeddings for each entity type in the set of entity types, generating, using the retrieved ontology embeddings for the knowledge graph, node embeddings for the subject node and the object node included in the triple, scoring, using the generated node embeddings for the subject node and the object node included in the triple, the triple, and updating, using a loss of the scored triple, the ontology embeddings stored in the ontology lookup table.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The foregoing and other implementations can each optionally include one or more of the following features, alone or in combination. In some implementations the ontology embeddings further comprise embeddings for each relation type in the knowledge graph.

In some implementations the method further comprises, for each triple: randomly replacing either the subject node included in the triple or the object node included in the triple with a randomly selected node in the knowledge graph to generate a corrupted triple; generating, using the retrieved ontology embeddings for the knowledge graph, node embeddings for the subject node and the object node included in the corrupted triple; and scoring the corrupted triple, wherein embeddings used to score the corrupted triple comprise the generated node embeddings for the subject node and the object node included in the corrupted triple, wherein updating the ontology embeddings comprises using a loss of the scored triple and a loss of the scored corrupted triple to update the ontology embeddings.

In some implementations generating node embeddings for the subject node and the object node included in the triple comprises: for a target node in the triple: identifying, from the plurality of triples, a k-hop subgraph of the knowledge graph, wherein the k-hop subgraph comprises k-hop neighbor nodes of the target node; and generating an embedding for the target node using ontology embeddings for entity types of the k-hop neighbor nodes of the target node.

In some implementations generating an embedding for the target node using ontology embeddings for entity types of the k-hop neighbor nodes of the target node comprises: initializing, for each node in the k-hop subgraph and using the ontology embeddings for entity types of the k-hop neighbor nodes of the target node, an embedding for the node as equal to an embedding for the entity type of the node; and processing the initialized embeddings through multiple relational message passing layers and a readout layer to generate an embedding for the target node.

In some implementations processing the initialized embeddings through multiple relational message passing layers to generate an embedding for the target node comprises, for each relational message passing layer: for each triple in the k-hop subgraph, applying a message function to embedding for nodes included in the triple to generate respective messages; for each node in the k-hop subgraph, applying an aggregation function to aggregate messages that correspond to nodes in the k-hop subgraph that neighbor the node; for each node in the k-hop subgraph, applying an update function to an embedding for the node using the aggregated messages to obtain an updated embedding for the node.

In some implementations the method further comprises when the relational message passing layer is not a last relational message passing layer in the multiple relational message passing layers, providing the updated embeddings as input to a subsequent relational message passing layer, or when the relational message passing layer is a last relational message passing layer in the multiple relational message passing layers, applying a readout function to the updated embeddings to obtain the embedding for the target node.

In some implementations the message function is dependent on an entity type of the subject node included in the triple, an entity type of the object node included in the triple, and a relation type of the relation between the subject node and object node included in the triple.

In some implementations the aggregation function comprises an attention mechanism, wherein the attention mechanism is dependent on an entity type of the subject node included in the triple, an entity type of the object node included in the triple, and a relation type of the relation between the subject node and object node included in the triple.

In some implementations the update function is dependent on an entity type of the node of the embedding to be updated.

In some implementations the method further comprises updating, using the loss of the scored triples, parameters of the multiple relational message passing layers using backpropagation.

In some implementations updating, using a loss of the scored triples, the ontology embeddings stored in the ontology lookup table comprises performing backpropagation of gradients of the loss of the scored triples.

In some implementations the method further comprises using the trained neural link predictor for knowledge graph completion tasks.

In some implementations using the trained neural link predictor for knowledge graph completion tasks comprises: receiving, at inference time, a request to score a new knowledge graph triple, wherein the new knowledge graph triple comprises a subject node included in the plurality of triples and an object node included in the plurality of triples; generating, using trained ontology embeddings included in the trained neural link predictor, node embeddings for the subject node and the object node included in the new knowledge graph triple; and scoring the new knowledge graph triple, wherein node embeddings used to score the new knowledge graph triple comprise the generated node embeddings for the subject node and the object node included in the new knowledge graph triple, the score indicating a likelihood that the new knowledge graph triple is factually correct.

In some implementations using the trained neural link predictor for knowledge graph completion tasks comprises: receiving, at inference time, a request to score a new knowledge graph triple, wherein the new knowledge graph triple comprises a subject node or an object node not included in the plurality of triples; generating, using trained ontology embeddings included in the trained neural link predictor, node embeddings for the subject node and the object node included in the new knowledge graph triple; and scoring the new knowledge graph triple, wherein node embeddings used to score the new knowledge graph triple comprise the generated node embeddings for the subject node and the object node included in the new knowledge graph triple, the score indicating a likelihood that the new knowledge graph triple is factually correct.

In some implementations using the trained neural link predictor for knowledge graph completion tasks comprises: receiving, at inference time, a request to score a triple from a new knowledge graph; generating, using trained ontology embeddings included in the trained neural link predictor, node embeddings for a subject node and an object node included in the triple from the new knowledge graph; and scoring the triple from the new knowledge graph, wherein node embeddings for scoring the triple from the new knowledge graph comprise the generated node embeddings for the subject node and the object node included in the triple from the new knowledge graph, the score indicating a likelihood that the triple from the new knowledge graph is factually correct.

In some implementations the new knowledge graph comprises a same ontology as the knowledge graph represented by the plurality of triples.

Some implementations of the subject matter described herein may realize, in certain instances, one or more of the following technical advantages.

Conventional neural link prediction systems are typically over-parameterized, that is they learn more parameters than needed. This leads to excessive memory usage during training, to the detriment of scalability when applied to large knowledge graphs, e.g. knowledge graphs that include billions of triples and more than tens of millions of nodes. In addition, over-parameterization can limit the neural link prediction system applicability to inductive link prediction settings.

To reduce this excessive memory usage during training, some conventional neural link prediction systems reduce the dimensionality of the embedding space [symbol] ^{k}. For example, setting k=100 instead of k=200 halves the memory usage. However, reducing the dimensionality of the embedding space can severely impact the predictive power of the neural link prediction system. Indeed, empirical evidence and public literature show that reducing the dimension to k<100 greatly degrades system performance.

Other conventional neural link prediction systems attempt to reduce excessive memory usage by introducing heuristics that avoid the need to learn a whole knowledge graph embedding matrix during training, e.g., heuristics that operate on subsets of the knowledge graph nodes. However, such heuristics typically require node distance or path calculations which are computationally expensive and affect scalability.

A technical problem to be solved in neural link prediction systems can therefore be formulated as the need to reduce the memory footprint of a neural link prediction systems such that the neural link prediction system's predictive power is not excessively degraded, computationally expensive heuristics are not required, and transductive and inductive link prediction are both supported.

This technical problem can be solved by the presently described ontology-driven neural link prediction system. Unlike conventional neural link prediction systems, the presently described ontology-driven neural link prediction system is memory and parameter efficient compared to conventional knowledge graph embedding methods, e.g., shallow embedding learning techniques. In addition, the presently described ontology-driven neural link prediction system includes a subgraph encoder that operates on an ontology embedding lookup table and does not require expensive node distance computations. Further, the presently described ontology-driven neural link prediction system supports both transductive and inductive link prediction tasks, where the inductive link tasks include tasks with unseen nodes (out-of-sample) or entirely new input graphs (e.g., if the new knowledge graph and the training knowledge graph share a same ontology.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of an example neural link prediction system.

FIG. 2 is a block diagram of an example process for learning ontology embeddings using an ontology-driven neural predictor system.

FIG. 3 is a block diagram of an example embedding generation layer.

FIG. 4 is a flowchart of an example process for training a ontology-driven neural link prediction system.

FIG. 5 is a flow chart of an example process for generating an embedding for a target node in a knowledge graph.

FIG. 6 is a flow chart of an example process for performing a knowledge completion task using a trained ontology-driven neural link predictor.

Like reference symbols in the various drawings indicate like elements.

### DETAILED DESCRIPTION

This specification describes an ontology-driven neural link prediction system that learns parameter and memory efficient knowledge graph embeddings for use in transductive and inductive link prediction tasks. The ontology-driven neural link prediction system includes an embedding generation layer that generates target knowledge graph node embeddings using an ontology lookup layer that stores learned ontology embeddings, e.g., entity and relation type embeddings, and a subgraph encoder that operates on a k-hop neighboring subgraph that encloses the target knowledge graph nodes.

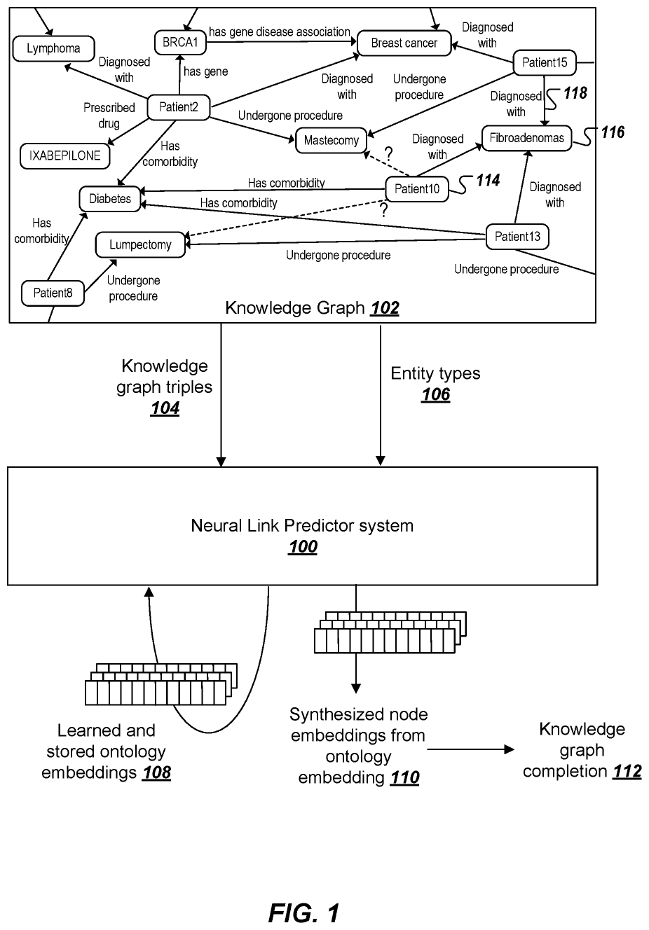

FIG. 1 is a block diagram of an example ontology-driven neural link prediction system 100. The example ontology-driven neural link prediction system 100 is configured to learn vector representations (referred to herein as “embeddings”) of concepts from a knowledge graph 102 to perform knowledge graph completion tasks, e.g., to predict unseen links between nodes in the knowledge graph.

The knowledge graph 102 includes a set of nodes, e.g., nodes 114 and 116, where directed edges, e.g., edge 118, between nodes represent relations between the nodes. The knowledge graph 102 is a multi-relational graph, that is nodes are connected by multiple types of edges. The knowledge graph 102 can be denoted as [symbol] ⊆ [symbol] × [symbol] × [symbol] , where [symbol] represents the set of nodes and [symbol] represents a set of relation types.

The knowledge graph 102 is specified by a collection of triples that represent links (also referred to as “facts”) in the data underlying the knowledge graph. A tuple is a n-ary set of elements. A triple is a trinary set that includes three values. For example, a triple can be represented as t=(s, p, o), where s corresponds to a respective node and represents a subject, o corresponds to a respective node and represents an object, and p corresponds to an edge and represents a predicate that describes the relationship between the nodes connected by the edge.

Each node in the knowledge graph represents an entity and has an entity type. The entity types are dependent on the type of data that the knowledge graph represents. For example, the knowledge graph 102 shown in FIG. 1 is a knowledge graph of a decision support system that predicts whether a patient needs to undergo a certain medical procedure. In this example, the entity type for the node “Patient2” is “patient,” the entity type for the node “Breast cancer” is “disease,” and the entity type for the node “Masectomy” is “surgical procedure.” Since the node “Patient2” is connected to the node “Masectomy,” an example triple that appears in knowledge graph 102 is t=(“patient2”, undergone procedure, “masectomy”) where “patient2” is the object entity, “undergone procedure” is the predicate, and “mastectomy” is the object entity. This triple links patient2 to the surgical procedure mastectomy, i.e., represents the fact that patient2 had a mastectomy.

The ontology-driven neural link predictor system 100 is configured to receive knowledge graph triples 104 that specify the knowledge graph 102 as input. Unlike conventional knowledge graph embedding models, the presently described ontology-driven neural link predictor system 100 is also configured to receive the set of entity types § 106 for the knowledge graph. This additional input specifies the schema, i.e., ontology, of the knowledge graph 102.

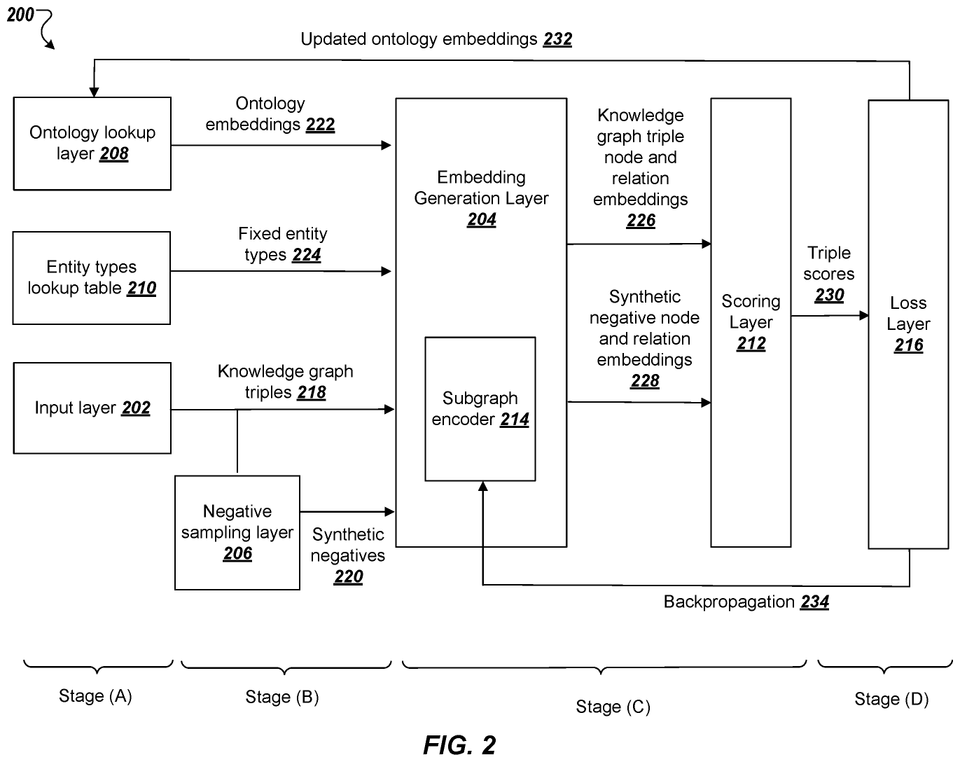

The ontology-driven neural link predictor system 100 is configured to process the received knowledge graph triples and the set of entity types to learn an ontology embedding matrix. The ontology embedding matrix includes embeddings for each relation type in the knowledge graph and embeddings for each entity type in the set of entity types for the knowledge graph, i.e., {eᵣ, ∀rϵ [symbol] }∪{eₑ, ∀eϵε} where [symbol] represents the set of relation types and ε represents the set of entity types. The relation type embeddings and entity type embeddings are collectively referred to herein as ontology embeddings 108. Each ontology embedding is a k-dimensional vector of real numbers that represents a respective entity type, where in some implementations k can lie in the range 100<k<500. The ontology embeddings provide an internal representation of the entity and relation types in the input knowledge graph 102. Example operations performed by the ontology-driven neural link predictor system 100 to learn ontology embeddings are described below with reference to FIG. 2.

Learning ontology embeddings (instead of embeddings for each node and relation type in the knowledge graph as in conventional knowledge graph embedding models) provides several technical advantages. For example, since the size of the set of entity types is smaller than the size of the set of knowledge graph nodes, storing embeddings for each entity type in the set of entity types reduces the number of parameters stored in memory. Storing node embeddings requires an amount of space in memory that scales as (| [symbol] |+| [symbol] |)^{d}, where [symbol] represents the set of nodes, [symbol] represents the set of relation types, and d represents embedding space dimensionality. Conversely, the presently described ontology embeddings require an amount of space in memory that scales as (|ε|+| [symbol] |)^{d}, where ε represents the set of entity types and |ε|<<| [symbol] |. Moreover, the presently described ontology-driven neural link prediction system only stores in memory the node embeddings required by triples included in a training batch (unlike conventional methods that store embeddings of each node in the graph).

The presently described ontology-driven neural link prediction system is therefore more memory and parameter efficient compared to conventional neural link prediction systems.

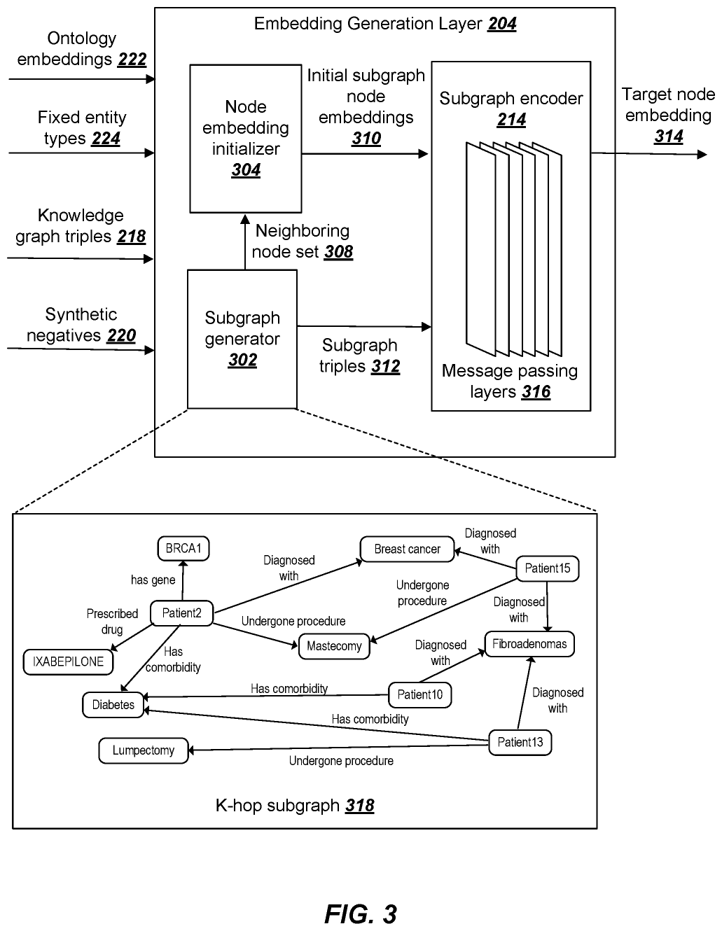

The ontology-driven neural link predictor system 100 includes a subgraph encoder that is configured to use the learned ontology embeddings to synthesize individual node embeddings 110. For example, to compute a node embedding for the node “Patient 10,” the subgraph encoder can retrieve the learned ontology embeddings and the list of triples covering the k-hop subgraph enclosing the node from memory and use the learned ontology embedding to synthesize an embedding for the node. Example operations performed by the ontology-driven neural link predictor system 100 to learn ontology embeddings are described below with reference to FIG. 3.

Individual node embeddings 110 computed by the ontology-driven neural link predictor system 100 can be used for a downstream task, e.g., knowledge graph completion 112. Example types of knowledge graph completion tasks include link prediction and relation prediction. Link prediction is the task of predicting a target knowledge graph node given a knowledge graph entity and predicate, e.g., the task of predicting the subject or object node of a triple associated with a missing link in the knowledge graph, t=(s, p, ?) or t=(?, p, o). Relation prediction is the task of predicting a relationship between two given knowledge graph nodes, e.g., the task of predicting the relation type of the triple associated with a missing link between a subject and an object node in the knowledge graph t=(s, ?, o), as illustrated by the dotted edges in the knowledge graph 102 of FIG. 1.

Knowledge graph completion can be accomplished either in transductive or inductive settings. In transductive settings, all data entities are observed on the triples of the knowledge graph. At inference time, completion of the knowledge graph is realized by predicting missing links between the observed set of entities. In inductive settings, the knowledge graph can be completed using unobserved data entities or in a new knowledge graph that is different to the knowledge graph used during training.

As described in more detail below with reference to FIGS. 2-6, the presently described ontology-driven neural link predictor system 100 learns ontology embeddings and parameters of the subgraph encoder, which are transferable to new knowledge graph data. Because of this, the presently described ontology-driven neural link predictor system 100 supports both transductive and inductive link prediction. That is, the presently described ontology-driven neural link predictor system 100 can generate a node representation of a node arriving at test time, while it was unseen at training time. In particular, the ontology-driven neural link predictor system 100 can generate node embeddings for a completely new knowledge graph with a same ontology, e.g., a new knowledge graph with a set of relation and entity types that are the same as the training knowledge graph.

FIG. 2 is a block diagram of an example process for learning ontology embeddings using an ontology-driven neural predictor system 200. The block diagram illustrates the example learning process as including four stages (A), (B), (C), and (D). However, in some implementations the example learning process can include fewer or more stages. Each of the four stages are illustrated as being performed by respective components of the ontology-driven neural predictor system. However, in some implementations, different stages of the example training process can be performed by other computing modules.

The ontology-driven neural predictor system 200 includes an input layer 202, an embedding generation layer 204, a negative sampling layer 206, an ontology lookup layer 208, an entity types lookup table 210, a scoring layer 212, and a loss layer 216. These components can be connected via a network, e.g., a local area network (LAN), wide area network (WLAN), the Internet, or a combination thereof, which can be accessed over a wired and/or a wireless communications link.

During stage (A), the input layer 202 provides the embedding generation layer 204 and the negative sampling layer 206 with an input knowledge graph in the form of knowledge graph triples 218. As described above, each triple is represented as t=(s, p, o), where s and o correspond to respective nodes in the knowledge graph and represent a subject entity and an object entity, and p corresponds to an edge in the knowledge graph and represents a predicate.

The ontology lookup layer 208 is configured to store an ontology embedding matrix that includes ontology embeddings, i.e., embeddings for each entity type and relation type in the knowledge graph as described above with reference to FIG. 1. The ontology embeddings are updated and learned during training, as described in more detail below. During stage (A), the ontology lookup layer 208 is configured to provide the ontology embeddings 222 to the embedding generation layer 204. For example, during training the ontology lookup layer 208 can provide ontology embeddings for the current learning epoch to the embedding generation layer 204. The ontology lookup layer 208 provides the learned ontology embeddings to the embedding generation layer 204 for use in generating individual node embeddings.

The entity types lookup table 210 is configured to store a set of entity types E for the input knowledge graph. The set of entity types includes an entity type of each node in the input knowledge graph. The set of entity types is dependent on the input knowledge graph and can be defined and fixed in advance, e.g., before the ontology embeddings are learned. During stage (A), the entity types lookup table 210 is configured to provide the set of entity types 224 to the embedding generation layer 204.

During stage (B), the negative sampling layer 206 is receives the knowledge graph triples 218 and generates corrupted versions of some or all of the knowledge graph triples (e.g., generates corrupted versions of the triple for the current iteration). Corrupted versions of the knowledge graph triples are referred to herein as synthetic negatives 220. To generate a synthetic negative of a triple t=(s, p, o), the negative sampling layer can be configured to randomly replace either the subject entity s or object entity o in the triple with an entity that is randomly selected from the knowledge graph. The negative sampling layer 206 provides the generated synthetic negatives 220 to the embedding generation layer 204.

During stage (C), the embedding generation layer 204 receives the knowledge graph triples 218 from the input layer 202, the synthetic negatives 220 from the negative sampling layer 206, the set of entity types 224 from the entity types lookup table 210, and the ontology embeddings 222 from the ontology lookup layer 208. The embedding generation layer 204 then generates embeddings 226 of nodes involved in the knowledge graph triples 218 and synthetic negatives 220. Unlike conventional knowledge graph embedding models, the embedding generation layer 204 uses a subgraph encoder 214 and the ontology embeddings 222 stored in the ontology lookup layer 208 to generate individual node embeddings, as described in detail below with reference to FIG. 3. The embedding generation layer 204 is configured to provide generated node embeddings to the scoring layer 212.

Further, during stage (C), the scoring layer 212 receives the knowledge graph triple's nodes and relations embeddings 226 and the synthetic negative's node and relation embeddings 228 from the embedding generation layer 204. The scoring layer 212 is configured to compute scores using knowledge graph triple's nodes and relations embeddings 226 and synthetic negative's node and relation embeddings 228 by applying a scoring function. The specific scoring function used by the scoring layer 212 can vary. In some implementations the scoring function can be a function that uses distances, e.g., a TransE scoring function. In other implementations the scoring function can use bilinear-diagonal models such as ComplEx or DistMult scoring functions or a scoring function that uses circular correlation such as a HoIE scoring function.

Scores 230 output by the scoring layer 212 indicate likelihoods that respective knowledge graph triples or synthetic negatives are factually correct, e.g., where a higher score indicates a higher likelihood that a corresponding triple is factually correct. The scoring layer 212 can be considered as a way to assign a probability to each fact of the knowledge graph.

During stage (D), the loss layer 216 receives the scores 230 from the scoring layer 212 and uses the scores 230 to compute a loss. For example, in implementations where the scoring layer 212 uses a TransE scoring function, the scoring layer 212 computes a similarity between i) an embedding of a subject entity in a triple translated by an embedding of a predicate in the triple and ii) an embedding of an object entity in the triple using the L2 norm (Euclidean distance), as given in Eq. 1 below.

$${f}_{TransE} = - {‖ {e}_{s} + {e}_{p} - {e}_{o} ‖}_{2} \qquad ( 1 )$$

In Eq. 1, eₛ represents the embedding of the subject entity, eₚ represents the embedding of the predicate, and eₒ represents the embedding of the object entity. These scores can be used to compute a pairwise margin-based loss given by the loss function in Eq. 2 below.

$$ℒ ( Θ ) = {\sum }_{{t}^{+} ∈ 𝒢} {\sum }_{{t}^{-} ∈ 𝒩} max ( 0 , [ γ + {f}_{m} ( {t}^{-} ; Θ ) - {f}_{m} ( {t}^{+} ; Θ ) ] ) \qquad ( 2 )$$

In Eq. 2, Θ represents the learnable parameters of the model, e.g., the ontology embeddings and the parameter set of the subgraph encoder, t⁺ϵ [symbol] represents a knowledge graph triple in the set of knowledge graph triples, t⁻ϵ [symbol] represents a synthetic negative from the set of negative triples generated by the negative sampling layer 206, fₘ represents the scoring function, and γϵ [symbol] represents a margin.

The ontology-driven neural predictor system 200 can compute gradients of the loss computed by the loss layer 216 with respect to the learnable parameters. The ontology embeddings 232 are updated by backpropagating the computed gradients. The updated ontology embeddings are ontology embeddings that improve the likelihood that the scoring layer 212 scoring function assigns high scores to facts that are likely to be true and low scores to facts that are unlikely to be true. In addition, the ontology-driven neural predictor system 200 can use the computed gradients of the loss to perform backpropagation 234 and determine updated values of parameters the subgraph encoder 214.

The stages (A)-(D) can be applied over multiple epochs until learned ontology embeddings and learned values of the parameters of the subgraph encoder 214 are determined, e.g., until a loss threshold is met or until a computed loss converges. After the ontology embeddings have been learned, stages (A)-(C) (excluding the negative sampling which is a training strategy) can be performed to generate node embeddings for downstream tasks such as knowledge graph completion, as described above with reference to FIG. 1.

FIG. 3 is a block diagram of the example embedding generation layer 204 shown in FIG. 2. The embedding generation layer 204 includes a subgraph generator 302, node embedding initializer 304, and multi-layer subgraph encoder 214. These components can be connected via a network, e.g., a local area network (LAN), wide area network (WLAN), the Internet, or a combination thereof, which can be accessed over a wired and/or a wireless communications link.

As described above with reference to FIG. 2, the embedding generation layer 204 is configured to receive as input knowledge graph triples 218, synthetic negatives 220 corresponding to some or all of the knowledge graph triples 218 (e.g., the corresponding to the current training batch), a set of entity types 224 for the knowledge graph, and stored ontology embeddings 222.

The subgraph generator 302 is configured to receive the knowledge graph triples 218 surrounding the target node. A target node is a node for which the embedding generation layer 204 is to generate an embedding for. For example, during training, each node involved in the input knowledge graph triples 218 and synthetic negatives 220 to be scored in a current training batch becomes a target node.

For each identified target node, the subgraph generator 302 is configured identify a list of k-hop neighboring nodes of the target node, e.g., using the knowledge graph triples 218. For example, the subgraph generator 302 can first identify a list of first-hop neighbors of the target node. The first-hop nodes of the target node are nodes that are directly connected to the target node in the knowledge graph. The subgraph generator 302 is then configured to expand the list of first-hop nodes to include second-hop nodes of the target node, which are nodes that are directly connected to the first-hop nodes in the knowledge graph. The subgraph generator 302 can repeatedly expand the list of nodes belonging to the subgraph up to k-hop neighbors, for some predefined k. The computations performed by the subgraph generator 302 does not require computing distances of neighbouring nodes, which can be computationally expensive. An example k-hop subgraph 318 of knowledge graph 102 in FIG. 1 is shown in FIG. 3. The subgraph 318 corresponds to k=3 and encloses the target node “Patient10.”

The subgraph generator 302 is configured to provide the neighboring node set of the k-hop subgraph 308 to the node embedding initializer 304. The node embedding initializer 304 is configured to receive the neighboring node set of the k-hop subgraph 308, as well as the set of entity types 224 for the knowledge graph and the ontology embeddings 222.

The node embedding initializer 304 is configured to set initial vector representations of the nodes in the subgraph as their corresponding entity type embeddings. For example, for each node included in the neighboring node set of the k-hop subgraph, the node embedding initializer 304 can search the entity types 224 to identify an entity type of the node and search the ontology embeddings 222 to obtain an embedding for the node. The node embedding initializer 304 can then set an initial vector representation of the node as equal to the obtained entity type embedding. That is, the node embedding initializer 304 can set

$${h}_{j}^{( 0 )} = {e}_{τ ( j )} , \qquad ( 3 )$$

where hⱼ^{(l)} represents a vector representation of node j at layer l of the subgraph encoder, {τ(j)ϵε, ∀jϵ [symbol] ⁱ} represents the set of entity class labels τ(j) for each node j in the neighboring node set [symbol] ⁱ of the target node i, hⱼ⁽⁰⁾ is a vector representing initial embedding for node j and e_{τ(j)} is a vector that represents the embeddings for entity types τ(j).

The node embedding initializer 304 is configured to provide the initial vector representations of the nodes in the subgraph (initial subgraph node embeddings) 310 to the subgraph encoder 214. The subgraph encoder 214 is also configured to receive triples for the k-hop subgraph 312 from the subgraph generator 302, as well as the entity types 224 and the ontology embeddings 222. The subgraph encoder 214 is configured to process these inputs using multiple relational message-passing layers 316 and a relational attention mechanism to generate, as output, an embedding of the target node 314. Each layer l=1, 2, . . . of the multiple relational message-passing layers 316 is configured to perform the operations described below.

The relational message-passing layers 316 are responsible for the exchange of vector representations between neighboring nodes in the subgraph and updating them. For each triple in the subgraph, the subject and object of the triple send a message to each other and receive a message from each other. For example, on an arbitrary triple t=(s, r, o), at layer l, node s receives a message mₒ^{(l)} from its neighboring node o. The message mₒ^{(l)} is computed through application of a message function using the representation node o at layer l, hₒ^{(l)}, and the embedding eᵣ of the relation type rϵ [symbol] included in the triple. If the layer is the initial layer, l=0, the message function is applied to the initialized vector representation of node o, ho₍₀₎, constructed by the node embedding initializer 304. The message operation can be formulated by Eq. 4 below.

$${m}_{o}^{( l )} = {f}_{MESSAGE}^{〈 τ ( s ) , r , τ ( o ) 〉} ( {h}_{o}^{( l )} , {e}_{r} ) \qquad ( 4 )$$

This message function is specific to the counterparts' types of the triple over which the message is passing: triple's subject node type τ(s) and triple's object node type τ(o) and triple's relation type τ(o). Unlike conventional message functions, the message function given by Eq. (4) exploits the input entity type information in addition to the relation type of the triple. This design choice diversifies the computation of the message based on the receiver node type, sender node type and the relation type between them.

The message function in Eq. (4) computes a message vector mₒ^{(l)}ϵ [symbol] ^{d} of the neighbor node o to be delivered to the receiver node s.

This function uses the representation of the neighbor node hₒ^{(l)} at the current layer l and the representation of the relation eᵣ connecting the neighbor to the receiver node in order to compute the message. The message is computed by applying certain transformations on the input vector representations and on the combination of them specific to the type of the message function [symbol] τ(s), r, τ(o) [symbol] .

Then, for each node in the subgraph, the relational message-passing layer computes aggregation of received messages from its neighbors through application of an aggregation function to the messages. The aggregation of the messages received at node s is denoted by aₛ^{(l)}. For example, the aggregation of messages for node s can be computed using the aggregation function given in Eq. 5 below.

$${a}_{s}^{( l )} = {f}_{AGGREGATE} ( \{ ( {α}_{( s , r ( s , o ) , o )} , {m}_{o}^{( l )} ) \vert o ∈ {𝒩}_{s}^{i} \} ) \qquad ( 5 )$$

The aggregation function incorporates an attention mechanism. In Eq. 5, α_{(s,r(s,o),o)} represents the attention weight for the message computed from node o to node s. The function r(s, o) returns a relation type between node s and o, and [symbol] ₛⁱ represents the neighbouring nodes of node s within the subgraph centered on the target node i. In some implementations an aggregation function is a weighted averaging of the input messages using their corresponding attention weights. The weighted average aggregation can be computed by multiplying each input message representation with its corresponding weight and dividing the sum of the weighted input message representations by the sum of the weights.

The attention weight α_{(s,r(s,o),o)} for the message coming from neighbor node o to the receiver node s can be computed using an attention function applied to the embedding of the receiver node, hₛ^{(l)}, embedding of its neighbor hₒ^{(l)} at the current layer, and also embedding of the triple's relation type eᵣ. For example, the attention weight can be computed using the attention function given in Eq. 6 below.

$${α}_{( s , r , o )} = {f}_{ATTENTION}^{〈 τ ( s ) , r , τ ( o ) 〉} ( {h}_{s}^{( l )} , {h}_{o}^{( l )} , {e}_{r} ) \qquad ( 6 )$$

The attention function is also specific to the counterparts' types of the triple over which the message is passing: triple's subject node type τ(s) and triple's object node type τ(o) and triple's relation type τ(o) (as indicated by the subscript of the attention weights). The attention function can apply certain transformations at the input representations and on the combinations of them that is specific to the type of the attention function [symbol] τ(s),r,τ(o) [symbol] . Such a relational attention mechanism in the aggregation can increase the quality of the embeddings generated by the embedding generation layer 204.

Then, for each node in the subgraph, the relational message-passing layer updates its node representation using the aggregated messages. For example, for node s, the update step combines the aggregated messages aₛ^{(l)} with the vector representation hₛ^{(l)} of the node s from the current layer and generates a vector representation hₛ^{(l+1)} of node s for the next layer. The update function is parameterized with respect to the type of the subject entity s, τ(s), which is derived from the entity type lookup table 210. This design choice diversifies the computation of the node representations for the next layer based on their type. For example, the updated vector representation can be computed using the updated function described in Eq. 7 below.

$${h}_{s}^{( l + 1 )} = {f}_{UPDATE}^{τ ( s )} ( {h}_{s}^{( l )} , {a}_{s}^{( l )} ) \qquad ( 7 )$$

The update function computes the representation of a node for the next layer, hₛ^{(l+1)} by applying transformations on its current layer representation hₛ^{(l)} using the aggregated message representation for that node aₛ^{(l)}, which is specific to the entity type of that node.

If the relational message-passing layer (layer l) is not a last layer, the relational message-passing layer provides the updated vector representations for each node in the subgraph 318 as input to a subsequent relational message-passing layer (layer l+1) of the multiple message passing layers 316 (the L message passing layers). The subsequent relational message-passing layer can then repeat the operations described above using its own layer parameters.

If the relational message-passing layer is last layer in the multiple message passing layers 316 (layer L), a readout function is applied to the last layer vector representations of the nodes in the subgraph to generate an embedding of the target node i. The readout function can be given by Eq. 8 below.

$${e}_{i} = {f}_{READOUT}^{τ ( i )} ( \{ {h}_{j}^{( L )} \vert j ∈ {v}^{i} \} ) \qquad ( 8 )$$

The readout function aggregates all the node representations in the subgraph in order to extract the individual node representation of the target node-i 314 that will be used in the scoring layer 212. The readout function is parameterized with respect to the type of the target node, τ(i), which is derived from the entity type lookup table 210. This design choice diversifies the computation of the individual node representations with respect to their entity types.

The readout function computes the individual embedding of the target node eᵢ by applying certain transformations on the last layer representation of the nodes in the subgraph and combining them specifically to the type of the target node τ(i).

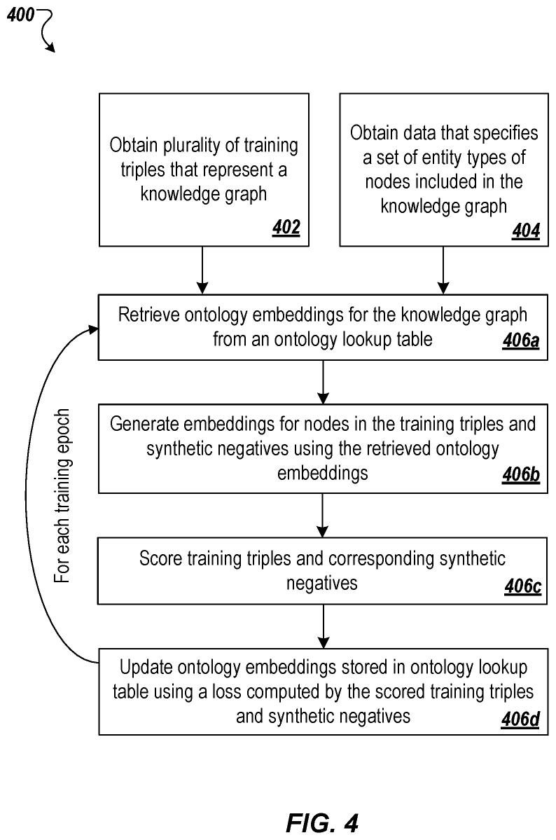

FIG. 4 is a flow chart of an example process 400 for training an ontology-driven neural link prediction system. For convenience, the process 400 will be described as being performed by a system of one or more computers located in one or more locations. For example, the neural link prediction system 200 of FIG. 2, appropriately programmed, can perform example process 400.

The system obtains a set of triples that represent a knowledge graph (step 402). Each triple in the set includes data that specifies a subject node in the knowledge graph, an object node in the knowledge graph, and a relation type between the subject node and object node. In some implementations the system can use the set of triples to generate a corresponding set of corrupted triples (also referred to herein as synthetic negatives). For example, for each triple in the plurality of triples, the system can randomly replace either the subject node or the object node included in the triple with a randomly selected node in the knowledge graph to generate a corresponding corrupted triple.

The system obtains data that specifies a set of entity types of nodes in the knowledge graph (step 404). The system can obtain the entity type data from a lookup table that stores fixed entity types of each node in the knowledge graph.

The system iteratively processes the triples and corrupted triples obtained at step 402 to train the ontology-driven neural link prediction system. At each iteration (for each training epoch), the system retrieves ontology embeddings for the knowledge graph from an ontology lookup table (step 406a). The ontology embeddings include embeddings for each entity type in the set of entity types and embeddings for each relation type in the knowledge graph, and are updated at each iteration of the training process to obtain learned ontology embeddings. For example, at a first iteration, the system can retrieve initial ontology embeddings and perform steps 406a-406d to generate updated ontology embeddings. In subsequent iterations, the system can retrieve ontology embeddings generated in a previous iteration and perform steps 406a-406d to further update the ontology embeddings.

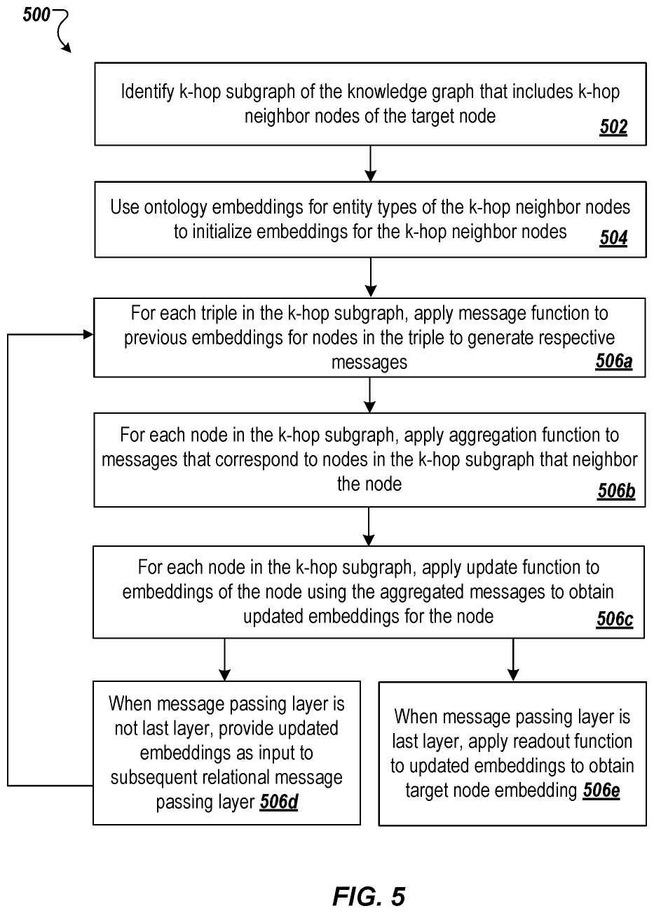

At each iteration, the system generates node embeddings for the subject node and the object node included in the triple and the corrupted triple for the iteration using the retrieved ontology embeddings (step 406b). In other words the system generates embeddings for nodes involved in the training triples and synthetic negatives. An example process for generating node embeddings using an ontology-driven neural link prediction system is described below with reference to FIG. 5.

At each iteration, the system scores the triple and the corrupted triple using embeddings associated with the triple (step 406c). The embeddings associated with the triple include the subject node embedding for the triple and the object node embedding for the triple generated at step 406b and a relation type embedding for the relation between the subject node and the object node, as specified by the ontology embeddings obtained at step 406a. Similarly, embedding associated with the corrupted triple include the subject node embedding for the corrupted triple and the object node embedding for the corrupted triple generated at step 406b and a relation type embedding for the relation between the subject node and the object node, as specified by the ontology embeddings obtained at step 406a. The system can score the triple and the corrupted triple using a scoring function, as described above with reference to FIG. 2. The scores obtained at step 406c provide an indication as to whether the triple is factually correct and therefore plausible or not, e.g., where a higher score indicates a higher likelihood that the triple is correct.

The system uses the scores computed at step 406c to compute a loss of the scored triple and the scored corrupted triple, e.g., through application of a loss function such as a pairwise margin based loss function. Example loss functions are described above with reference to FIG. 2. The system updates the ontology embeddings stored in the ontology lookup table using the computed loss (step 406d). For example, the system can compute gradients of the computed loss with respect to the ontology embedding parameters, and backpropagate the computed gradients to adjust the ontology embeddings stored in the ontology lookup table. The system can also backpropagate the computed gradients to adjust and train the subgraph encoder, e.g., parameters of the multiple relational message passing layers.

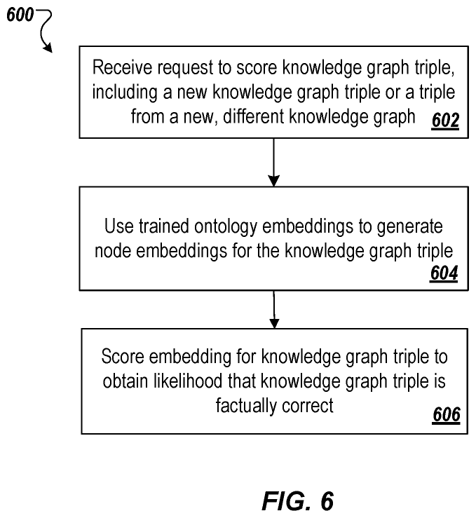

After each triple (and its corresponding corruption) have been processed, the system can provide the trained ontology-driven neural link prediction system for use in downstream tasks, e.g., knowledge graph completion tasks. An example process for performing a knowledge completion task using a trained ontology-driven neural link predictor is described below with reference to FIG. 6.

FIG. 5 is a flow chart of an example process 500 for generating an embedding for a target node in a knowledge graph. For convenience, the process 500 will be described as being performed by a system of one or more computers located in one or more locations. For convenience, the process 500 will be described as being performed by a system of one or more computers located in one or more locations. For example, the embedding generation layer 204 of FIGS. 2 and 3, appropriately programmed, can perform example process 500.

The system identifies, from a plurality of triples representing the knowledge graph, a k-hop subgraph of the knowledge graph (step 502). The k-hop subgraph is a subgraph that includes k-hop neighbor nodes of the target node.

The system uses ontology embeddings for entity types of the k-hop neighbor nodes of the target node to generate an embedding for the target node. For each node in the k-hop subgraph, the system initializes an embedding for the node as equal to an embedding for the entity type of the node (step 504). The system then processes the initialized embeddings through multiple relational message passing layers and a readout layer to generate an embedding for the target node.

At each relational message passing layer, the system performs steps 506a-d as described below. For each triple in the k-hop subgraph, the system applies a message function to embeddings for nodes included in the triple as received from a previous layer (or as computed at step 504) to generate respective messages (step 506a). The message function can be dependent on an entity type of the subject node included in the triple, an entity type of the object node included in the triple, and a relation type of the relation between the subject node and object node included in the triple. Example message functions are described in more detail above with reference to FIG. 3.

Further, for each node in the k-hop subgraph, the system applies an aggregation function to aggregate messages computed at step 506a that correspond to the nodes (step 506b). In some implementations the aggregation function can include an attention mechanism, where the attention mechanism is dependent on an entity type of the subject node included in the triple, an entity type of the object node included in the triple, and a relation type of the relation between the subject node and object node included in the triple. Example aggregation functions and attention mechanisms are described in more detail above with reference to FIG. 3.

For each node in the k-hop subgraph, the system applies an update function to embeddings of the node using the aggregated messages to obtain updated embeddings of the node (step 506c). In some implementations the update function can depend on an entity type of the node of the embedding to be updated. Example update functions are described in more detail above with reference to FIG. 3.

When the relational message passing layer is not a last relational message passing layer in the multiple relational message passing layers, the system provides the updated embeddings as input to a subsequent relational message passing layer (506d), where the subsequent relational message passing layer repeats steps 506a-506d (according to the subsequent relational message passing layer's parameters).

When the relational message passing layer is a last relational message passing layer in the multiple relational message passing layers, the system applies a readout function to the updated embeddings to obtain the embedding for the target node (506e).

FIG. 6 is a flow chart of an example process 600 for performing a knowledge completion task using a trained ontology-driven neural link prediction system. For convenience, the process 600 will be described as being performed by a system of one or more computers located in one or more locations. For example, the neural link prediction system 200 of FIG. 2, appropriately programmed and trained used the techniques described in this disclosure, can perform example process 600.

The system receives a request to score a knowledge graph triple (step 602). In some implementations the knowledge completion task can be a transductive completion task. For example, the knowledge completion task can be the task of predicting a missing link between a subject node and an object node that were both observed in the triples used to train the ontology-driven neural link prediction system. In these implementations the system can receive a request to score a new knowledge graph triple, where the new knowledge graph triple includes a subject node included in the set triples and an object node included in the set of triples.

In other implementations, the knowledge completion task can be an inductive completion task. For example, the knowledge completion task can be the task of predicting a link between a node that was observed in the triples used to train the ontology-driven neural link prediction system and another node that was not observed in the triples used to train the ontology-driven neural link prediction system. In these implementations the system can receive a request to score a new knowledge graph triple, where the new knowledge graph triple includes a subject node or an object node that was not included in the set of triples. As another example, the knowledge completion task can be the task of predicting links from a new knowledge graph that is different to the knowledge graph used to train the ontology-driven neural link prediction system. In these implementations the system can receive a request to score a triple from a new knowledge graph, where the new knowledge graph has a same ontology (e.g., entity types and relation types) as the knowledge graph represented by the set of triples.

The system uses the trained ontology embeddings included in the ontology-driven neural link prediction system to generate node embeddings for the subject node and the object node included in the knowledge graph triple received at step 602, e.g., the new knowledge graph triple or triple from the new knowledge graph (step 604). For example, the system can apply example process 500 (e.g., once where the subject node is the target node and once where the object node is the target node) to generate the node embeddings. For brevity, details are not repeated.

The system generates node embeddings for the knowledge graph triples received at step 602. Using the node embeddings generated at step 604 and a relation type embedding for the relation included in the knowledge graph triple, the system scores the knowledge graph triple. The score indicates a likelihood that the knowledge graph triple is factually correct (step 606). The system can use the score to determine whether the knowledge graph triple represents a missing or unobserved link in the knowledge graph.

Implementations and all of the functional operations described in this specification may be implemented in digital electronic circuitry, or in computer software, firmware, or hardware, including the structures disclosed in this specification and their structural equivalents, or in combinations of one or more of them. Implementations may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular implementations have been described. Other implementations are within the scope of the following claims. For example, the actions recited in the claims may be performed in a different order and still achieve desirable results.

What is claimed is:

1. A computer implemented method for training a neural link predictor, the method comprising:
obtaining a plurality of triples that represent a knowledge graph, wherein each triple in the plurality of triples comprises data that specifies a subject node in the knowledge graph, an object node in the knowledge graph, and a relation type between the subject node and object node;
obtaining data that specifies a set of entity types of nodes in the knowledge graph; and
for each triple:
retrieving, from an ontology lookup table, ontology embeddings for the knowledge graph, the ontology embeddings comprising embeddings for each entity type in the set of entity types,
generating, using the retrieved ontology embeddings for the knowledge graph, node embeddings for the subject node and the object node included in the triple,
scoring, using the generated node embeddings for the subject node and the object node included in the triple, the triple, and
updating, using a loss of the scored triple, the ontology embeddings stored in the ontology lookup table.

2. The method of claim 1, wherein the ontology embeddings further comprise embeddings for each relation type in the knowledge graph.

3. The method of claim 1, further comprising, for each triple:
randomly replacing either the subject node included in the triple or the object node included in the triple with a randomly selected node in the knowledge graph to generate a corrupted triple;
generating, using the retrieved ontology embeddings for the knowledge graph, node embeddings for the subject node and the object node included in the corrupted triple; and
scoring the corrupted triple, wherein embeddings used to score the corrupted triple comprise the generated node embeddings for the subject node and the object node included in the corrupted triple,
wherein updating the ontology embeddings comprises using a loss of the scored triple and a loss of the scored corrupted triple to update the ontology embeddings.

4. The method of claim 1, wherein generating node embeddings for the subject node and the object node included in the triple comprises:
for a target node in the triple:
identifying, from the plurality of triples, a k-hop subgraph of the knowledge graph, wherein the k-hop subgraph comprises k-hop neighbor nodes of the target node; and
generating an embedding for the target node using ontology embeddings for entity types of the k-hop neighbor nodes of the target node.

5. The method of claim 4, wherein generating an embedding for the target node using ontology embeddings for entity types of the k-hop neighbor nodes of the target node comprises:
initializing, for each node in the k-hop subgraph and using the ontology embeddings for entity types of the k-hop neighbor nodes of the target node, an embedding for the node as equal to an embedding for the entity type of the node; and
processing the initialized embeddings through multiple relational message passing layers and a readout layer to generate an embedding for the target node.

6. The method of claim 5, wherein processing the initialized embeddings through multiple relational message passing layers to generate an embedding for the target node comprises, for each relational message passing layer:
for each triple in the k-hop subgraph, applying a message function to embedding for nodes included in the triple to generate respective messages;
for each node in the k-hop subgraph, applying an aggregation function to aggregate messages that correspond to nodes in the k-hop subgraph that neighbor the node;
for each node in the k-hop subgraph, applying an update function to an embedding for the node using the aggregated messages to obtain an updated embedding for the node.

7. The method of claim 6, further comprising:
when the relational message passing layer is not a last relational message passing layer in the multiple relational message passing layers, providing the updated embeddings as input to a subsequent relational message passing layer, or
when the relational message passing layer is a last relational message passing layer in the multiple relational message passing layers, applying a readout function to the updated embeddings to obtain the embedding for the target node.

8. The method of claim 6, wherein the message function is dependent on an entity type of the subject node included in the triple, an entity type of the object node included in the triple, and a relation type of the relation between the subject node and object node included in the triple.

9. The method of claim 6, wherein the aggregation function comprises an attention mechanism, wherein the attention mechanism is dependent on an entity type of the subject node included in the triple, an entity type of the object node included in the triple, and a relation type of the relation between the subject node and object node included in the triple.

10. The method of claim 6, wherein the update function is dependent on an entity type of the node of the embedding to be updated.

11. The method of claim 5, further comprising updating, using the loss of the scored triples, parameters of the multiple relational message passing layers using backpropagation.

12. The method of claim 1, wherein updating, using a loss of the scored triples, the ontology embeddings stored in the ontology lookup table comprises performing backpropagation of gradients of the loss of the scored triples.

13. The method of claim 1, further comprising using the trained neural link predictor for knowledge graph completion tasks.

14. The method of claim 13, wherein using the trained neural link predictor for knowledge graph completion tasks comprises:
receiving, at inference time, a request to score a new knowledge graph triple, wherein the new knowledge graph triple comprises a subject node included in the plurality of triples and an object node included in the plurality of triples;
generating, using trained ontology embeddings included in the trained neural link predictor, node embeddings for the subject node and the object node included in the new knowledge graph triple; and
scoring the new knowledge graph triple, wherein node embeddings used to score the new knowledge graph triple comprise the generated node embeddings for the subject node and the object node included in the new knowledge graph triple, the score indicating a likelihood that the new knowledge graph triple is factually correct.

15. The method of claim 13, wherein using the trained neural link predictor for knowledge graph completion tasks comprises:
receiving, at inference time, a request to score a new knowledge graph triple, wherein the new knowledge graph triple comprises a subject node or an object node not included in the plurality of triples;
generating, using trained ontology embeddings included in the trained neural link predictor, node embeddings for the subject node and the object node included in the new knowledge graph triple; and
scoring the new knowledge graph triple, wherein node embeddings used to score the new knowledge graph triple comprise the generated node embeddings for the subject node and the object node included in the new knowledge graph triple, the score indicating a likelihood that the new knowledge graph triple is factually correct.

16. The method of claim 13, wherein using the trained neural link predictor for knowledge graph completion tasks comprises:
receiving, at inference time, a request to score a triple from a new knowledge graph;
generating, using trained ontology embeddings included in the trained neural link predictor, node embeddings for a subject node and an object node included in the triple from the new knowledge graph; and
scoring the triple from the new knowledge graph, wherein node embeddings for scoring the triple from the new knowledge graph comprise the generated node embeddings for the subject node and the object node included in the triple from the new knowledge graph, the score indicating a likelihood that the triple from the new knowledge graph is factually correct.

17. The method of claim 16, wherein the new knowledge graph comprises a same ontology as the knowledge graph represented by the plurality of triples.

18. A system comprising one or more computers and one or more storage devices storing instructions that are operable, when executed by the one or more computers, to cause the one or more computers to perform operations for training a neural link predictor, the operations comprising:
obtaining a plurality of triples that represent a knowledge graph, wherein each triple in the plurality of triples comprises data that specifies a subject node in the knowledge graph, an object node in the knowledge graph, and a relation type between the subject node and object node;
obtaining data that specifies a set of entity types of nodes in the knowledge graph; and
for each triple:
retrieving, from an ontology lookup table, ontology embeddings for the knowledge graph, the ontology embeddings comprising embeddings for each entity type in the set of entity types,
generating, using the retrieved ontology embeddings for the knowledge graph, node embeddings for the subject node and the object node included in the triple,
scoring, using the generated node embeddings for the subject node and the object node included in the triple, the triple, and
updating, using a loss of the scored triple, the ontology embeddings stored in the ontology lookup table.

19. A computer-readable storage medium comprising instructions stored thereon that are executable by a processing device and upon such execution cause the processing device to perform operations for training a neural link predictor, the operations comprising:
obtaining a plurality of triples that represent a knowledge graph, wherein each triple in the plurality of triples comprises data that specifies a subject node in the knowledge graph, an object node in the knowledge graph, and a relation type between the subject node and object node;
obtaining data that specifies a set of entity types of nodes in the knowledge graph; and
for each triple:
retrieving, from an ontology lookup table, ontology embeddings for the knowledge graph, the ontology embeddings comprising embeddings for each entity type in the set of entity types,
generating, using the retrieved ontology embeddings for the knowledge graph, node embeddings for the subject node and the object node included in the triple,
scoring, using the generated node embeddings for the subject node and the object node included in the triple, the triple, and
updating, using a loss of the scored triple, the ontology embeddings stored in the ontology lookup table.
